(19) United States
(12) Patent Application Publication
(10) Pub. No.: US 2007/0119612 A1
(43) Pub. Date: May 31, 2007

(54) Wire cable

(75) Inventor: Martin Knagge, Seesen (DE)

Correspondence Address: WILLIAM COLLARD;COLLARD & ROE, P.C., 1077 NORTHERN BOULEVARD, ROSLYN, NY, 11576, US

(73) Assignee: Telefex Automotive Germany GmbH

(21) Appl. No.: 11/392,513

(22) Filed: Mar. 29, 2006

(30) Foreign Application Priority Data
Nov. 29, 2005 (DE) 10 2005 057 184.0

(51) Int. Cl. H01B 9/02

(52) U.S. Cl. 174/108

(57) ABSTRACT

A wire cable for transmitting motions inside a control cable sheath, preferably to transmit the motion of a gearshift or selector lever to the transmission of a motor vehicle, is formed by a core and wires placed around it. The core wire is enclosed by multiple helical wires that constitute at least one wire layer. At least one enclosing wire has a larger diameter (b) than the other enclosing wires, so that a wire cable is formed with an out-of-round diameter along the wire.

### BACKGROUND OF THE INVENTION

1. Field of the Invention

The invention relates to a wire cable for use wherever a force is to be transmitted between the transmission of a motor vehicle and the gearshift lever, whereby only slight friction is to occur during the transmission of force and there is to be no transmission of oscillations and vibrations to the gearshift lever.

2. The Prior Art

To transmit the force of the gearshift lever to the transmission, typically a wire connection has been placed between the transmission and the gearshift lever. To this end, one wire can be arranged to transmit the selector motion, and one wire to transmit the shifting motion. To transmit these forces, different wires have been used, which are usually arranged as the core of a cable control line. If a round wire is used, as a rule relatively large clearance exists to the adjacent or surrounding parts, so that vibrations are transmitted. These vibrations on the manual gearshift lever are unpleasant for the driver. For this reason, the manual gearshift lever that is operated by the driver has to be decoupled from these vibrations. Additional variant methods have to be implemented in the manual gearshift lever for this decoupling, which involves additional expense for constructing the manual gearshift lever.

German Patent No. DE 199 28 302 B1 discloses a device for fastening control line elements of cables, preferably for gearshift systems of motor vehicles, that is distinguished by a coupling element, whereby additional bulk is positioned. This fastening device serves to decouple the vibrations on the core of the cable control line so that they are not transmitted to the manual gearshift lever.

Another method is the use of oval wires to transmit the force from the transmission to the manual gearshift lever. Oval wire cable structures, of course, have the drawback that there is too much play toward two sides, so that vibrations can nevertheless be transmitted.

German Patent No. DE 200 00 430.1 describes a control cable line sheath for control lines between the controls and the transmission of vehicles of all kinds that minimize interfering vibrations and keep the play of the cable control line small. With this, there is the ability to eliminate the transmission of vibrations and to diminish the large play of a round cable control line sheath.

### SUMMARY OF THE INVENTION

Therefore, it is an object of this invention to construct a wire cable that has low friction and that transmits vibrations only to a very small degree.

This object is accomplished by a wire cable for transmitting motions inside a cable control line sheath, preferably for transmitting the motions of a gearshift or selector lever to the transmission of a motor vehicle, with the wire cable consisting of a core wire that is enclosed helically by multiple wires that constitute at least one wire layer. The enclosing wires also have different diameters from one another so that a wire cable with an out-of-round diameter along the wire is formed.

The wires enclosing the core wire have at least two diameters, i.e. a larger diameter and a smaller diameter.

It is advantageous to provide each of the multiple enclosing wires with a large or small diameter. In a preferred embodiment, one wire has a larger diameter. However, two or more wires can also have a larger diameter than the other wires. Because of this, there are two or more places at which the enclosing wires of larger diameter rest on the cable control line sheath. It is conceivable also to make every other wire with a larger diameter, with the friction of the wire with the cable control line sheath being increased along with the number of larger wires that contact the cable control line sheath.

It is also possible for all wires around the core wire each to have different diameters.

It is advantageous for the core wire to consist of multiple individual wires.

In the same way, it is also possible to have the surrounding wires consist of individual wires. In turn, several variants are conceivable for this, namely providing a core wire consisting of a single wire enclosed by wires that consist of a variable number of individual wires. It is also possible to enclose a core wire consisting of multiple individual wires with an enclosing wire that consists of a number of individual wires, with the wires of smaller diameter being made as individual wires. Because the enclosing wire that has the larger diameter consists of multiple individual wires, its diameter can be made exactly such that the point of contact with the cable control line sheath turns out to be even smaller, so that the friction factor becomes still smaller along with the cable control line sheath.

A gap is formed between the cable control line sheath and the other enclosing wires that encloses most of the surface of the wire helically along the wire, and no friction occurs over its length, and vibrations are transmitted only to a small degree.

Both the core wire and the individual wires preferably consist of metal or metal alloy.

It is also advantageous for multiple wire layers to enclose the core wire.

The internal core wire is enclosed like a planet by the individual wires with different diameters, to form an out-of-round cross section that accordingly produces an oval rest area/contact surface. The variable contact of the wire layers and individual wires can be designed in variable contact right- or left-hand lay lengths.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a top view of one embodiment of the wire cable according to the invention; and

FIG. 2 shows a cross-sectional view of the wire cable of FIG. 1.

### DETAILED DESCRIPTION OF THE PREFERRED EMBODIMENT

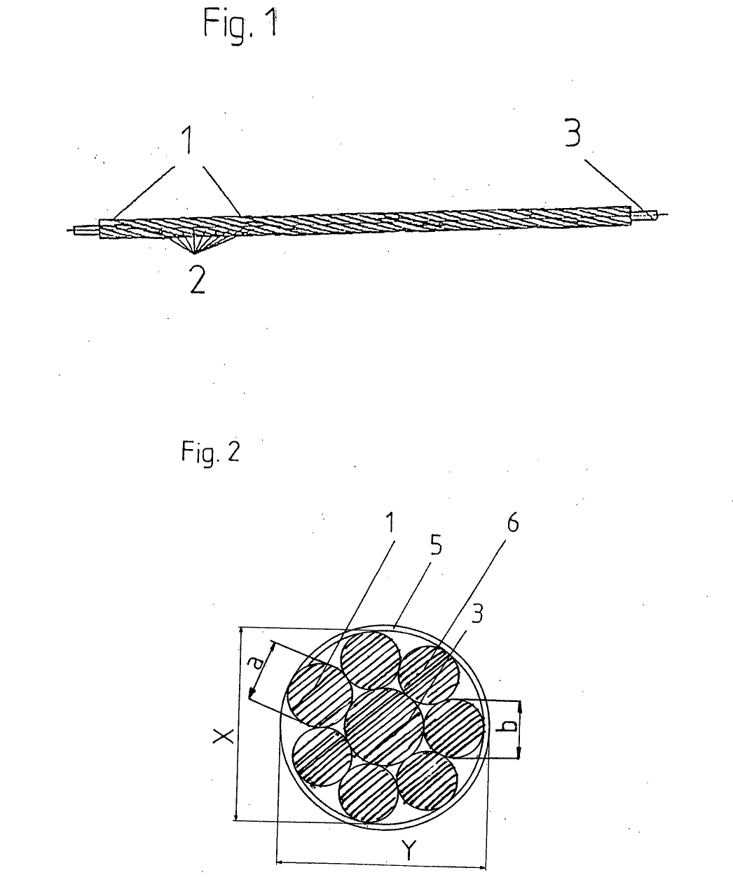

Referring now in detail to the drawings, FIG. 1 shows one embodiment of the wire cable, consisting of a core wire 3 consisting of one wire, and individual wires 1, 2 in top view, wherein there is variable contact of the wire layers along the wire, since wire 1, which has a larger diameter than wire 2, leads to different diameters over the length of the wire. Thus the wire rests on the sheath at only few places, so that few points of friction with the sheath are present and little vibration is transmitted.

FIG. 2 shows how core wire 3 in the center of the wire cable structure is enclosed by wires 1, 2 of different diameters a, b, so that consequently the width X of the wire is smaller at the points shown than its height Y, with the diameter a being smaller than the diameter b of the wire 1. The wire contacts sheath 4 only at a place whose inside diameter is shown in FIG. 2 and forms a gap 5 to the rest of the sheath.

Accordingly, while only a few embodiments of the present invention have been shown and described, it is obvious that many changes and modifications may be made thereunto without departing from the spirit and scope of the invention.

1. A wire cable for transmitting motion inside a control cable sheath, comprising:
a core wire; and
a plurality of surrounding helical wires placed around the core wire to form at least one wire layer, wherein one of said surrounding wires has a larger diameter (b) than other of said surrounding wires, so that a wire cable is formed with an out-of-round diameter and the one surrounding wire having the larger diameter is an individual wire.

2. (canceled)

3. A wire cable pursuant to claim 1, wherein the core wire consists of an individual wire.

4. A wire cable pursuant to claim 1, wherein at least some of the surrounding wires consist of individual wires.

5. A wire cable pursuant to claim 1, wherein the core wire is an individual wire and each surrounding wire is an individual wire.

6. A wire cable pursuant to claim 1, wherein the core wire consists of a plurality of individual wires and at least one of the surrounding wires consists of a plurality of individual wires.

7. A wire cable pursuant to claim 1, wherein the core wire consists of an individual wire and at least one of the surrounding wires is made of a plurality of individual wires.

8. A wire cable pursuant to claim 1, wherein the core and surrounding wires consist of steel or a steel alloy.
